(19) United States
(12) Patent Application Publication
(10) Pub. No.: US 2022/0338625 A1
(43) Pub. Date: Oct. 27, 2022

(54) J-HOOK ROD HOLDER

(71) Applicant: Hebei Minmetals Co., Ltd., Shijiazhuang (CN)

(72) Inventor: Kebiao Hu, SHIJIAZHUANG (CN)

(21) Appl. No.: 17/585,002

(22) Filed: Jan. 26, 2022

Related U.S. Application Data
(60) Provisional application No. 63/179,718, filed on Apr. 26, 2021.

(51) Int. Cl. A47B 61/00; A47F 7/24

(52) U.S. Cl. CPC A47B 61/003; A47F 7/24; F16B 45/00

(57) ABSTRACT

A rod holder includes a first socket, the first socket located at the top of the rod holder, being C-shaped, and opening forward. A second socket is located below the first socket, is N-shaped, and opens downward. An U-shaped cradle resides opposite the first socket from the second socket and opens upward. A rod holder body has a first end connected to the first and second sockets and a second end connected to the cradle. The first and second sockets reside in a plane, and the cradle resides forward of the plane and the rod holder body extends rearward from the plane. The cradle may include one or more protrusions proximate to its opening. A method of installing a rod holder is also provided.

### CROSS REFERENCE TO RELATED APPLICATIONS

This application claims the benefit of priority of U.S. Provisional Application Ser. No. 63/179,718, filed on Apr. 26, 2021, which is incorporated herein in its entirety.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIALS SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR A JOINT INVENTOR

Not applicable.

### BACKGROUND OF THE INVENTION

### Field of the Invention

The present disclosure is generally related to a rod holder and more particularly related to a rod holder for connecting to a wire shelf.

### Description of the Related Art

The subject matter discussed herein should not be assumed to be prior art merely as a result of its mention in the related art section. Similarly, a problem mentioned in the related art section or associated with the subject matter of the related art section should not be assumed to have been previously recognized in the prior art. The subject matter in the related art section merely represents different approaches, which in and of themselves may also correspond to implementations of the claimed technology.

Modern storage areas such as closets, wardrobes, and garages may require holding and stacking various accessories such as clothes and other objects. Such holding and stacking may be facilitated by using wire shelves. Typically, a wire shelf consists of spaced longitudinal rods extending along the length of the shelf and smaller wire shelving rods extending transversely front to rear over the longitudinal rods. The longitudinal rods may include a pair of horizontally spaced rods, one in the front of the shelf and one in the rear of the shelf, optionally with one or more intermediate rods between the front and rear rods. The wire shelving rods are spaced over the tops of the front to rear rods. In many examples, two longitudinal rods are located at the front of the shelf, one located vertically above the other. In such applications, the wire shelving rods are turned down at their fronts and attached to both of the two front longitudinal rods.

It may be desirable to include a clothes rod with the wire shelving. Such a clothes rod might be connected to the wire shelving and might allow for the hanging of coat hangers, clothes hangers, and other such hangers having an upper hook to facilitate suspending the device, the upper hook configured to overfit a clothes rod. Ideally, the clothes rod might be attached to the wire shelving with a holder that would allow for one or more coat hangers, clothes hangers, and other such hangers to be freely slidable along most of, or all of, the length of the clothes rod without interference from the holder, as a user peruses the items stored on the clothes rod by shifting such hangers longitudinally along the clothes rod. Still further, ideally such clothes rod holders might have the versatility of being easily installed upon a shelf, yet being easily moved from a first location upon a wire shelf to a second location upon the shelf, as a user may desire.

Therefore, there is a need for an improved design of a rod holder for use with wire shelving.

### BRIEF SUMMARY OF THE INVENTION

In response to the foregoing, a new, versatile, and movable rod holder has been discovered.

In accordance with certain aspects of certain embodiments of the present technology, a rod holder is provided that includes a first socket and a second socket, the first socket being open forward and the second socket being open downward. The rod holder further includes a cradle, the cradle being open upward. The second socket resides between the first socket and the cradle. The rod holder includes a body connected with the first socket, the second socket, and the cradle, and extending rearward from the first socket. Additionally and/or alternatively, in various embodiments one or more of the following aspects may also be included:
(a) the first and second sockets reside in a plane and the cradle resides forward of the plane;
(b) the body is J-shaped with an upper first end and a lower second end, the first and second sockets being located proximate to the first end and the cradle being located proximate to the second end;
(c) the rod holder defines an upper end and the first socket is located at the upper end;
(d) the cradle includes a protrusion proximate to the opening of the cradle;
(e) the cradle has first and second edges, first and second protrusions reside in the cradle, the first protrusion residing proximate to the first edge and the second protraction residing proximate to the second edge; and/or
(f) a method of installing a clothes rod, comprising the steps of:
   providing a wire shelf having upper and lower front longitudinal shelving rods;
   providing a rod holder as disclosed hereinabove within this Summary of Invention;
   fitting the lower front longitudinal shelving rod into the second socket;
   with the lower front longitudinal shelving rod fitted into the second socket, rotating the rod holder until the upper front longitudinal shelving rod is fitted into the first socket; and
   placing a clothes rod into the cradle.

In accordance with additional aspects of other embodiments of the present technology, a rod holder comprising an upper first socket and a lower second socket is provided. The first socket is forward-facing and C-shaped and the second socket is lower-facing and N-shaped. An upwardly-facing U-shaped cradle is included, the cradle being connected to the first and second sockets. The second socket resides between the first socket and the cradle. The first and second sockets reside in a plane and the cradle resides forward of the plane. Additionally and/or alternatively, in various embodiments one or more of the following aspects may also be included:
(a) a body that extends rearward of the cradle;
(b) a body that is attached to the first and second sockets and to the cradle, resides rearward of the cradle, and defines between the cradle and the first and second sockets a channel that resides in part below the cradle;
(c) a J-shaped body with an upper first end and a lower second end, the first and second sockets being located proximate to the first end and the cradle being located proximate to the second end;
(d) the cradle includes a protrusion proximate to the opening of the cradle;
(e) the cradle has first and second edges and a first protrusion resides proximate to the first edge and a second protraction resides proximate to the second edge; and/or
(f) a body defining an H-shaped cross-section.

In accordance with yet additional aspects of other embodiments of the present technology, a rod holder is provided that includes a first socket, the first socket being located at the top of the rod holder, being C-shaped, and opening forward. A second socket is included, the second socket being located below the first socket, being N-shaped, and opening downward. An U-shaped cradle is included, the cradle residing opposite the first socket from the second socket and opening upward. A rod holder body is also included, the rod holder body having a first end and an opposite second end, with the first end connected to the first and second sockets and the second end connected to the cradle. The first and second sockets reside in a plane and the cradle resides forward of the plane. Additionally and/or alternatively, in various embodiments one or more of the following aspects may also be included:
(a) the rod holder body extends rearward from the plane;
(b) the cradle includes a protrusion proximate to the opening of the cradle;
(c) the cradle has first and second edges and a first protrusion resides proximate to the first edge and a second protraction resides proximate to the second edge;
(d) the rod holder body defines an H-shaped cross-section; and/or
(e) a method of installing a rod holder, comprising the steps of:
   providing a wire shelf having upper and lower front longitudinal shelving rods;
   providing a rod holder as disclosed hereinabove in this Summary of Invention;
   fitting the lower front longitudinal shelving rod into the second socket; and
   with the lower front longitudinal shelving rod fitted into the second socket, fitting the upper front longitudinal shelving rod into the first socket.

Other advantages of the present invention will become apparent from the following descriptions, taken in connection with the accompanying drawings, wherein, by illustration and example, an embodiment of the present invention is disclosed.

### BRIEF DESCRIPTION OF THE SEVERAL VIEWS OF THE DRAWINGS

The accompanying drawings illustrate various embodiments of systems, methods, and configurations of various other aspects of the disclosure. It may be that in some examples one element may be designed as multiple elements or that multiple elements may be designed as a single element. Non-limiting and non-exhaustive descriptions are described with reference to the following drawings.

FIG. 1 illustrates a perspective view of a J-hook rod holder in accordance with an embodiment of the present invention;

FIG. 2 illustrates a perspective environmental view of a J-hook rod holder in accordance with an embodiment of the present invention;

FIG. 3 illustrates a side elevation environmental view of a J-hook rod holder in accordance with an embodiment of the present invention;

FIG. 4 illustrates a front elevation view of a J-hook rod holder in accordance with an embodiment of the present invention;

FIG. 5 illustrates a top plan view of a J-hook rod holder in accordance with an embodiment of the present invention;

FIG. 6 illustrates a back elevation view of a J-hook rod holder in accordance with an embodiment of the present invention;

It should be noted that the drawings discussed above and below are not to scale in all instances, but may have exaggerated dimensions in some respects to illustrate one or more of the principles of the invention.

### DETAILED DESCRIPTION OF THE INVENTION

Certain preferred embodiments and examples are disclosed herein. The inventive subject matter extends beyond the examples in the specifically disclosed embodiments to other alternative embodiments and/or uses, and to modifications and equivalents thereof. Thus, the scope of the claims below is not limited by any of the particular embodiments described herein. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Although any systems and methods similar or equivalent to those described herein can be used in the practice or testing of embodiments of the present disclosure, preferred systems and methods are now described. In describing the embodiments, specific terminology will be used for the sake of clarity. However, the invention is not intended to be limited to the specific terms so selected, and it is to be understood that each specific term includes all technical equivalents that function in a similar manner to accomplish a similar purpose.

Embodiments of the present disclosure will be described more fully hereinafter with reference to the accompanying drawings in which like numerals represent like elements throughout the several figures, and in which example embodiments are illustrated. Embodiments of the claims, however, may be in many different forms and should not be construed as limited to the embodiments set forth herein. The examples set forth herein are non-limiting and are merely among other possible examples. While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

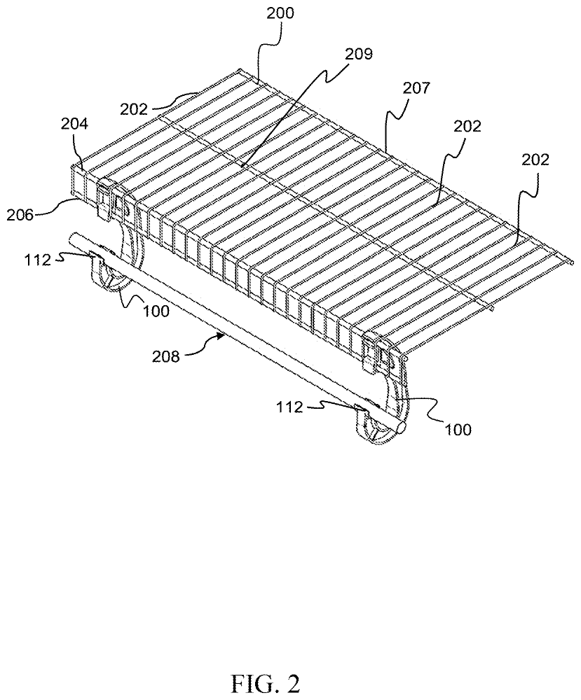

The words “comprising,” “having,” “including,” and forms thereof, are intended to be equivalent in meaning and be open ended in that an item or items following any one of these words is not meant to be an exhaustive listing of such item or items, or meant to be limited to only the listed item or items. The singular forms “a,” “an,” and “the” include plural references unless the context clearly dictates otherwise. The terms “upper,” “top,” and like terms refer to a direction relatively further from Earth. The term “lower,” “below,” and like terms refer to the direction opposite “upper,” a direction relatively closer to Earth. Unless specified or limited otherwise, the terms “connect,” “support,” “couple,” and variations thereof are used broadly and encompass direct and indirect connections, supports, and couplings; further, such terms are not restricted to physical or mechanical connections, supports, and/or couplings. The term “longitudinal” and variations thereof refer to the direction generally parallel to the length of shelving; the term “transverse” refers to the direction generally perpendicular to longitudinal. The terms “front,” “forward,” and like terms refer to the direction closer to a user of the subject shelving; for example, in FIG. 2 the rod holders 100 are connected to the front of wire shelf 200. The terms “back,” “rearward,” and like terms refer to the direction opposite “front” and “forward,” and more distal to a user of the subject shelving. The term “horizontal” refers to an orientation generally parallel to the horizon, and the term “vertical” refers to an orientation generally perpendicular to the horizon.

A rod holder 100 may comprise a rod holder body 101 having a first portion 102 and a second portion 104. The first portion 102 may have a shelf mounting block 106. The shelf mounting block 106 may further include a side-facing C-shaped first socket 108 and a lower-facing N-shaped second socket 110. Further, the second portion 104 of the rod holder 100 may include an upwardly extending U-shaped cradle 112. It may be noted that the first portion 102 of the rod holder 100 may correspond to an upper portion of the rod holder 100 and the second portion 104 of the rod holder 100 may correspond to a lower portion of the rod holder 100.

The shelf mounting block 106 may be configured to connect the rod holder 100 to a wire shelf 200. The first socket 108 may be located at the top of mounting block 106/rod holder 100. Further, the first socket 108 of the rod holder 100 may comprise of two arms—a first arm 114 and a second arm 116—that may facilitate the rod holder 100 being connected to an upper front longitudinal shelving rod 204 of a wire shelf 200.

The shelf mounting block 106 may also comprise the second socket 110, which may reside below first socket 108. The second socket 110 of the rod holder 100 may comprise of two arms—third arm 118 and fourth arm 120—that may facilitate the rod holder 100 being connected to a lower front longitudinal shelving rod 206 of a wire shelf 200. It can be noted that the shelf mounting block 106 comprising the first socket 108 and the second socket 110, together, may facilitate a stable connection of the rod holder 100 to a wire shelf 200.

In one embodiment, the rod holder body 101 of the rod holder 100 may comprise one or more braces 122. A brace 122 is a strengthening feature, such as a beam or truss, configured within or attached to the rod holder body 101, adding material to the rod holder body 101 at select locations. It can be noted that the braces 122 may bolster the rod holder 100 with strength when load is applied on the rod holder 100.

The cradle 112 of the rod holder 100 may include a first edge 131 and a second edge 132, first and second edges 131, 132 defining the opening to the cradle 112. Cradle 112 may also include a first protrusion 124 residing at first edge 131 or at second edge 132. It can be noted that the first protrusion 124 may facilitate the clipping of a clothes rod 208 into the cradle 112, to hold clothes rod 208 within cradle 112. The first protrusion 124 may facilitate the cradle 112 to hold a clothes rod 208 in place in the cradle 112. In some applications, the cradle 112 may also include a second protrusion 125, disposed opposite the first protrusion 124. More specifically, the cradle 112 may include a first protrusion 124 residing at first edge 131 and a second protrusion 125 residing at second edge 132. Together, first protrusion 124 and second protrusion 125 may facilitate cradle 112 holding a clothes rod 208 in place in the cradle 112 by snap fit engagement.

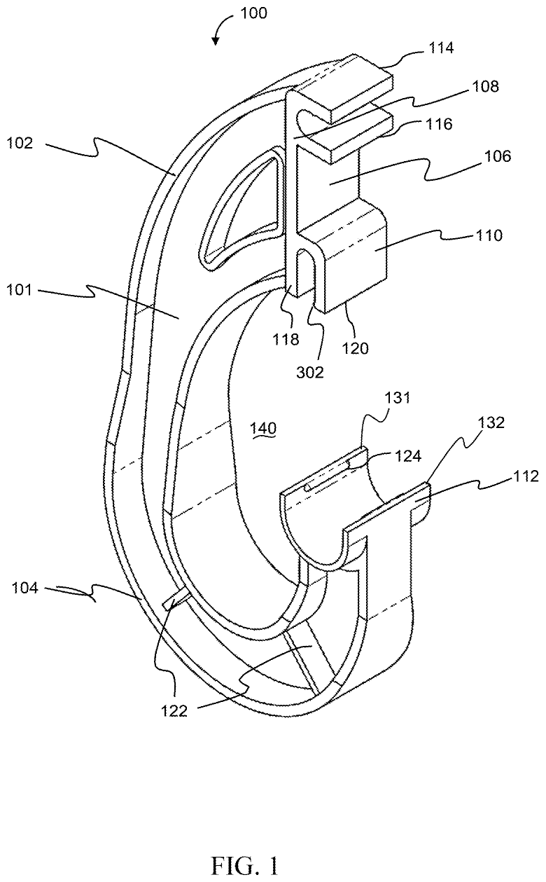

In another embodiment, the rod holder 100 may include a third protrusion 302 in the lower-facing N-shaped block 110 (see FIG. 1) and/or in the first socket 108 (not shown), to aid in fixing the rod holder 100 to the wire shelf 200.

In particular illustrations, the rod holder 100 is of generally J-shaped configuration with the shelf mounting block 106 being at the top of the “J” and the cradle 112 being provided at the lower terminating end of the second portion of the rod holder 100. Further, the cradle 112 may open upwardly and may have a diameter substantially the same as the diameter of a clothes rod 208 to be received therein. Further the cradle 112 may be provided with protrusions, such as first protrusion 124 and second protrusion 125, wherein the distance between the protrusions is less than the diameter of the clothes rod 208 which is to be received within the cradle 112—such relative dimensions may allow the clothes rod 208 to be snapped within the cradle 112 due to resiliency of the material of cradle 112. Further, the cradle 112 may include a recess therein of a depth and a width to receive a rod thereacross. For example, for a clothes rod 208 having a diameter of 1 inch, the distance between the protrusions 124, 125 may be less than 1 inch, and the depth and width of the cradle may be approximately 1 inch, thereby allowing for a snap fit engagement of the clothes rod 208 into the cradle 112.

A wire shelf 200 may comprise longitudinally extending wire shelving rods. Specifically, in select configurations, an upper front longitudinal shelving rod 204, a lower front longitudinal shelving rod 206, and a back longitudinal shelving rod 207 may be included. Optionally, an intermediate longitudinal shelving rod 209 may also be included. Further, the wire shelf 200 may comprise a plurality of horizontally extending wire shelving rods 202. It can be noted that the horizontally extending wire shelving rods 202 may extend from the back of the wire shelf 200 to the front of the wire shelf 200 and over an upper front longitudinal shelving rod 204 and terminate at and be connected to a lower front longitudinal shelving rod 206.

It can be noted that the rod holder 100 of the present invention can be coupled to the wire shelf 200 and thus be particularly useful for receiving the clothes rod 208 therein. In some applications, the clothes rod 208 may be referred to as a clothes hanger rod.

The first socket 108 may couple with the upper front longitudinal shelving rod 204 of the wire shelf 200 and the second socket 110 may couple with the lower front longitudinal shelving rod 206 of the wire shelf 200. In one embodiment, the first socket 108 may interfit upon the upper front longitudinal shelving rod 204 of the wire shelf 200. Further, the second socket 110 may interfit upon the lower front longitudinal shelving rod 206 of the wire shelf 200.

In particular instances, the first and second sockets 108, 110 may reside in a plane and at least a majority of the cradle 112 may reside forward of the plane. Thus, once a rod holder 100 having that configuration is connected to a wire shelf 200 and a clothes rod 208 is connected within the cradle 112, a torque may be urged upon the rod holder 100, by reason of the forward location of the majority of the cradle 112 relative to the plane occupied by the first and second sockets 108, 110, such torque urging the first socket 108 to be interfitted upon the upper front longitudinal shelving rod 204. Further, such shelf mounting block 106 of the rod holder 100 may provide stability to the rod holder 100 when connected on the wire shelf 200. The rod holder 100 may eliminate the need of an additional member to support the rod holder 100 on the wire shelf 200. In one embodiment, the rod holder 100 may be easily interfitted onto the wire shelf 200 at a first location and later moved to a second, third, or fourth location of the wire shelf 200, without departing from the scope of the disclosure.

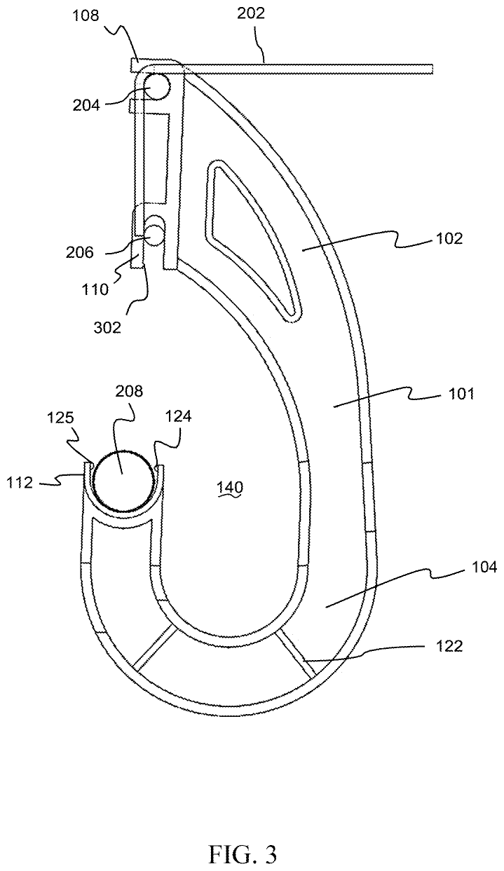

In one embodiment, the first socket 108 may comprise at least one protrusion (not shown) on the inner side of the first arm 114 and/or the second arm 116 of the first socket 108, to facilitate locking of the first socket 108 onto the upper front longitudinal shelving rod 204 of a wire shelf 200. Further, or alternatively, the second socket 110 may comprise at least a third protrusion 302 on the inner side of the third arm 118 and/or the fourth arm 120 of the second socket 110, to facilitate locking of the second socket 110 onto a lower front longitudinal shelving rod 206 of a wire shelf 200, as illustrated in FIG. 3.

The rod holder 100 may be fabricated from one or more than one material selected from the group metal, metal alloy, resin, plastic, or wood. In some embodiments, the rod holder 100 may be made up of some other materials and designed to support a ranging thickness of materials, without departing from the scope of the disclosure.

The disclosed embodiments encompass numerous advantages. Such a rod holder 100 may be tightened or locked onto the wire shelf 200. Such a rod holder 100 has an ability to be connected onto the wire shelf 200 without the use of power tools or skilled knowledge. Further, such a rod holder 100 improves the ease of use by allowing the rod holder 100 to be inventoried and assembled on-site. Additionally, the rod holder 100 may hold clothes rods 208 of various diameters. Furthermore, the clothes rod 208 may be removed and re-located at any time without requiring any power tools and/or skilled knowledge and therefore the removal of the clothes rod 208 may leave no holes, marks, or deformities on the rod holder 100.

Further, the rod holder 100 may be removed and reinstalled as needed with no actual wear visible on the rod holder 100. Therefore, such designs of rod holder 100 are optimal and result in increasing the ease and accessibility of the rod holder 100 without the use of power tools or skilled knowledge.

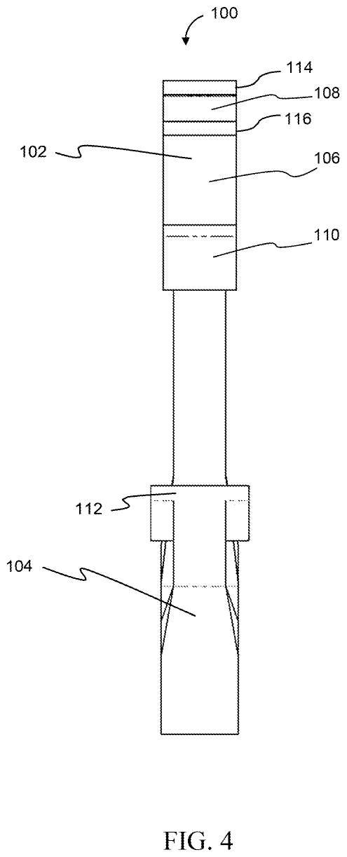

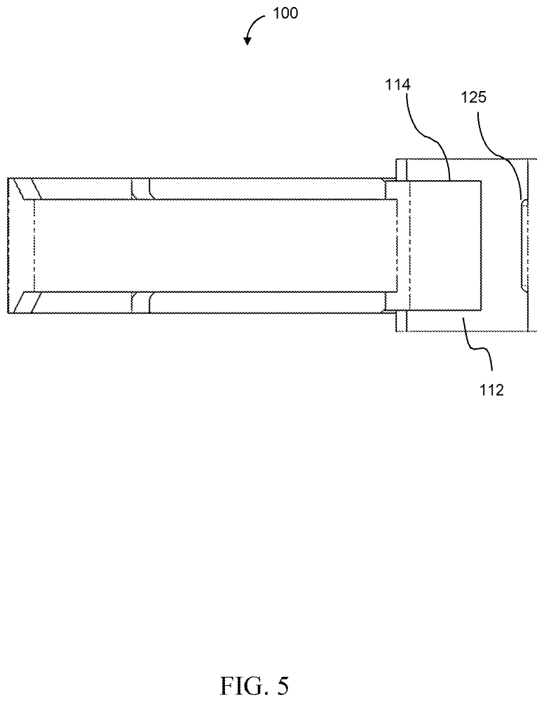

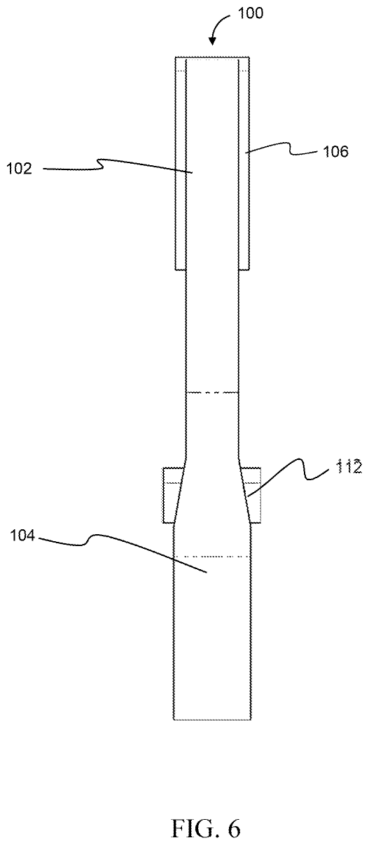

FIGS. 1, 4, 5, and 6 illustrate particular representations of certain embodiments of rod holder 100. Rod holder 100 includes a shelf mounting block 106 and a rod holder body 101. The rod holder body 101 defines an H-shaped cross-section and extends rearward of cradle 112. A first socket 108 is provided, the first socket 108 being located at the top of the rod holder 100, being C-shaped, and opening forward. First socket 108 includes a first arm 114 and a second arm 116. A second socket 110 is included, the second socket 110 being located below the first socket 108, being N-shaped, and opening downward. Second socket 110 includes a third arm 118 and a fourth arm 120. U-shaped cradle 112 resides opposite the first socket 108 from the second socket 110, and opens upward. The cradle 112 has first and second edges 131, 132 and first protrusion 124 resides proximate to the first edge 131, proximate to the opening of the cradle 112, and second protrusion 125 resides proximate to the second edge 132, proximate to the opening of the cradle 112. Rod holder body 101 has a first portion 102 and second portion 104, with the first portion 102 connected to the first and second sockets 108, 110 and the second portion 104 connected to the cradle 112. The rod holder body 101 defines between the cradle 112 and the first and second sockets 108, 110 a channel 140 that resides in part below the cradle 112. Clothes rod 208 is thereby attached to the wire shelving 200 in a configuration that allows for one or more coat hangers, clothes hangers, and other such hangers to be freely slidable along the length of the clothes rod without interference from the rod holder 100, as a user peruses the items stored on the clothes rod 208 by shifting such hangers longitudinally along the clothes rod 208, because of the channel 140 defined as described.

The first and second sockets 108, 110 reside in a plane and the cradle 112 resides forward of the plane; the rod holder body 101 extends rearward from the plane.

In FIGS. 2 and 3, a wire shelf 200 has been provided, wire shelf 200 having a upper front longitudinal shelving rod 204 and a lower front longitudinal shelving rod 206. In the illustration of FIG. 2, wire shelf 200 also includes a back longitudinal shelving rod 207 and an intermediate longitudinal shelving rod 209.

In FIGS. 2 and 3, rod holders 100 have been installed upon wire shelf 200. The rod holders 100 each include a first socket 108, the first socket 108 being located at the top of the rod holder 100, being C-shaped, and opening forward. The rod holders 100 also each include second socket 110, the second socket 110 being located below the first socket 108, being N-shaped, and opening downward. The rod holders 100 further each include a U-shaped cradle 112 residing opposite the first socket 108 from the second socket 110, and opening upward. The first and second sockets 108, 110 reside in a plane and the cradle 112 resides forward of the plane; the rod holder body 101 extends rearward from the plane.

In FIGS. 2 and 3, lower front longitudinal shelving rod 206 has been fitted into second socket 110. With the lower front longitudinal shelving rod 206 fitted into the second socket 110, upper front longitudinal shelving rod 204 has been fitted into the first socket 108 by rotating rod holders 100 such that first socket 108 approaches upper front longitudinal shelving rod 204 from the rear and receives upper front longitudinal shelving rod 204 within first socket 108. Thus, rod holders 100 have been connected to wire shelf 200. Clothes rod 208 has then been connected to cradles 112, providing for the hanging of coat hangers, clothes hangers, and other such hangers having an upper hook to facilitate suspending the device, the upper hook configured to overfit a clothes rod 208. Clothes rod 208 is thereby attached to the wire shelving 200 that allows for one or more coat hangers, clothes hangers, and other such hangers to be freely slidable along the length of the clothes rod without interference from the rod holder 100, as a user peruses the items stored on the clothes rod 208 by shifting such hangers longitudinally along the clothes rod 208. Rod holder 100 has the versatility of being easily installed upon a wire shelf 200, yet being easily moved from a first location upon a wire shelf 200 to a second location upon the shelf 200, as a user may desire.

The preceding examples, figures, discussion and explanations consider specific materials and conditions. It is to be understood that such specific details are given for illustrative purposes and not as limitations to be applied in interpreting the appended claims.

The foregoing description of a preferred embodiment of the invention has been presented for purposes of illustration and description. It is not intended to be exhaustive or to limit the invention to the precise form disclosed. Obvious modifications, variations or combination of embodiments are possible in light of the above teachings. The exemplary embodiments were chosen and described to provide an illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

While this invention has been described in conjunction with the specific embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of this invention.

What is claimed is:

1. A rod holder, comprising:
a first socket and a second socket, the first socket being open forward, the second socket being open downward;
a cradle, the cradle being open upward;
the second socket residing between the first socket and the cradle; and
a body connected with the first socket, the second socket, and the cradle and extending rearward from the first socket.

2. The rod holder of claim 1, wherein the first and second sockets reside in a plane and the cradle resides forward of the plane.

3. The rod holder of claim 1, in which the body is J-shaped with an upper first end and a lower second end, the first and second sockets being located proximate to the first end and the cradle being located proximate to the second end.

4. The rod holder of claim 1, in which the rod holder defines an upper end and the first socket is located at the upper end.

5. The rod holder of claim 1, wherein the cradle includes a protrusion proximate to the opening of the cradle.

6. The rod holder of claim 1, wherein the cradle has first and second edges, first and second protrusions reside in the cradle, the first protrusion residing proximate to the first edge and the second protraction residing proximate to the second edge.

7. A method of installing a clothes rod, comprising the steps of:
providing a wire shelf having upper and lower front longitudinal shelving rods;
providing the rod holder of claim 1;
fitting the lower front longitudinal shelving rod into the second socket;
with the lower front longitudinal shelving rod fitted into the second socket, rotating the rod holder until the upper front longitudinal shelving rod is fitted into the first socket; and
placing a clothes rod into the cradle.

8. A rod holder, comprising:
an upper first socket and a lower second socket;
the first socket being forward-facing and C-shaped;
the second socket being lower-facing and N-shaped;
an upwardly-facing U-shaped cradle, the cradle connected to the first and second sockets;
the second socket residing between the first socket and the cradle;
the first and second sockets residing in a plane;
the cradle residing forward of the plane.

9. The rod holder of claim 8, further including a body, the body extending rearward of the cradle.

10. The rod holder of claim 8, further including a body, the body:
attached to the first and second sockets and to the cradle;
residing rearward of the cradle;
defining between the cradle and the first and second sockets a channel, the channel residing in part below the cradle.

11. The rod holder of claim 8, further including a body, the body being J-shaped with an upper first end and a lower second end, the first and second sockets being located proximate to the first end and the cradle being located proximate to the second end.

12. The rod holder of claim 8, wherein the cradle includes a protrusion proximate to the opening of the cradle.

13. The rod holder of claim 8, wherein the cradle has first and second edges and a first protrusion resides proximate to the first edge and a second protraction resides proximate to the second edge.

14. The rod holder of claim 8, further including a body, the body defining an H-shaped cross-section.

15. A rod holder, comprising:
a first socket, the first socket located at the top of the rod holder, the first socket being C-shaped and opening forward;
a second socket, the second socket located below the first socket, the second socket being N-shaped and opening downward;
an U-shaped cradle, the cradle residing opposite the first socket from the second socket, the cradle opening upward;
a rod holder body, the rod holder body:
having a first end and an opposite second end;
the first end connected to the first and second sockets;
the second end connected to the cradle;
the first and second sockets residing in a plane; and
the cradle residing forward of the plane.

16. The rod holder of claim 15, wherein the rod holder body extends rearward from the plane.

17. The rod holder of claim 15, wherein the cradle includes a protrusion proximate to the opening of the cradle.

18. The rod holder of claim 15, wherein the cradle has first and second edges and a first protrusion resides proximate to the first edge and a second protraction resides proximate to the second edge.

19. The rod holder of claim 15, wherein the rod holder body defines an H-shaped cross-section.

20. A method of installing a rod holder, comprising the steps of:
providing a wire shelf having upper and lower front longitudinal shelving rods;
providing the rod holder of claim 15;
fitting the lower front longitudinal shelving rod into the second socket; and
with the lower front longitudinal shelving rod fitted into the second socket, fitting the upper front longitudinal shelving rod into the first socket.
